(19) United States
(12) Patent Application Publication
(10) Pub. No.: US 2017/0116882 A1
(43) Pub. Date: Apr. 27, 2017

(54) Method of improving foreign language skills using flash cards and a rolling dice

(71) Applicant: Gerard Charles Mooney, Dobbs Ferry, NY (US)

(72) Inventor: Gerard Charles Mooney, Dobbs Ferry, NY (US)

(21) Appl. No.: 14/756,854

(22) Filed: Oct. 22, 2015

(51) Int. Cl. G09B 19/08

(52) U.S. Cl. CPC G09B 19/08

(57) ABSTRACT

A method is provided for improving a person's skill in foreign language using playing cards and a rolling dice. The method uses two decks of cards, one deck consisting of cards each having a verb and an illustrative cartoon printed on one side of thereof with the English translation of the verb printed on the reverse side of that card, and another deck of cards, each having a noun and an illustrative cartoon on one side thereof and the English translation of the noun printed on the reverse side of that card. A rolling dice is provided having six sides (faces) with each of the six sides having a pronoun printed thereon. By drawing two cards, one from each deck and rolling the dice, a person will attempt to form a sentence based on the three words revealed by the two cards and the dice.

### FIELD OF THE INVENTION

The present invention relates generally to a method of improving a person's foreign language skills using flash cards and a rolling dice. It is particularly related to a method of improving a person's skill in the French language using two sets of decks of cards, side-by-side, one set of cards each having a French verb and an illustrative cartoon printed next to said verb on one side of each card, an English translation of the verb printed on the reverse side of that card, and another set of cards each having a French noun printed on each card and an illustrative cartoon printed next to said noun and an English translation of the French noun printed on the reverse side of that card, and a rolling dice having the six French pronouns printed on each of the six faces of the dice, the six French pronouns being “je”, “tu”, “il/elle/on”, “nous”, “vous” and “ils/elles”.

### BACKGROUND OF THE INVENTION

In the past, and even currently, two methods have been used to improve a person's skill in learning or improving the person's skill in a foreign language. One of these methods is the familiar class learning method, and the other is self-taught or go-it-alone method. Neither one of these methods, however, involve any activities or games for group practice or conversation.

There are numerous patents and publications relating to use of playing cards for learning foreign languages. A card game played with a deck of playing cards in a native language organized in the thematic suits is disclosed in Patent Publication No. US 2009/0280457 A1, published Nov. 12, 2009. U.S. Pat. No. 6,948,938 B1, issued Sep. 27, 2005 refers to several patents and patent publications wherein it discloses that many different games can be played using a standard 52 card deck. This patent discloses using a deck of playing cards containing a plurality of suits with at least one language wherein each card has thereon one or more characters, words, phrases and/or sentences in that particular language.

So far as is known, there are no patents or publication which disclose the use of flash cards together with a rolling dice which when used in accordance with the method of the invention can form a sentence of three words with the verb and pronoun agreeing in the present tense.

It is therefore an object of this invention to disclose a method of improving the language skills of a person by playing a game using flash cards, not necessarily 52 cards as in a deck of ordinary playing cards, together with an associated rolling dice to form a sentence.

It is also an object of this invention to provide a method of using two decks of flash cards, one set having a verb printed in French on one side of each card, and illustrative cartoon next to the verb which provides the clue to that verb, and the reverse side of each such card having a verb printed thereon which is the English translation of the word on the front side, another set of cards each having a French noun and an illustrative cartoon printed thereon and an English translation of the French noun printed on the reverse side of each such card, and a rolling dice having six faces with each face having printed thereon one of the six pronouns which, in the French language are “je”, “tu”, “il/elle/on”, “nous”, “vous” and “ils/elles.”

It is a specific object of this invention to provide a system consisting of flash cards and a rolling dice which when used in accordance with the method of this invention can form a sentence consisting of three or more words, utilizing one word from each card from the two decks of cards, and the pronoun from the rolling dice with the pronoun and verb agreeing in the present tense.

The foregoing and other objects of this invention will be more clearly understood with reference to the following detailed description and accompanying drawings.

### SUMMARY OF THE INVENTION

A new method is disclosed for improving a person's skill in learning a foreign language such as the French language, although the method and system described herein may be modified to apply for improving a person's skill in learning other languages. The method described herein is a game using two sets of flash cards and an associated rolling dice, the decks of cards need not be the familiar deck of 52 cards but may be any other deck consisting of as many cards at it is necessary to play the game.

In order to use the method of this invention for improving a person's skill in the French language, two decks of cards are used, one deck having a verb and an illustrative cartoon printed on the front side of each card and the English translation of the verb is printed on the reverse side of that card, and a second deck of cards having a noun and an illustrative cartoon printed on the front side of each card and its English translation printed on the reverse side of that card. A rolling dice having six sides (faces), with each side having the six French pronouns printed thereon is rolled before or after drawing one card from each deck and the player then attempts to form a sentence based on the three words, one word from each the cards of the two decks of cards and the third, a pronoun from the rolling dice, thus forming a sentence with the verb and pronoun agreeing in the present tense, which sentence can provoke conversation and dialogue among the players.

### BRIEF DESCRIPTION OF THE DRAWINGS

In the drawings, wherein like reference numerals designate like parts:

FIG. 1 shows two decks of cards placed in two adjacent racks, side by side in a stand with the left rack consisting of cards having a verb printed on each card and an illustrative drawing or cartoon character which provides a hint to the meaning of that verb, and the right set of cards having a noun printed thereon with an illustrative drawing or cartoon character which provides a hint to its meaning;

FIG. 2A shows the front of the individual card from the left deck of cards shown in FIG. 1;

FIG. 2B shows the reverse side of the card illustrated in FIG. 2A having the corresponding English translation of that word printed thereon;

FIG. 3A shows the front of the individual card from the right deck of cards shown in FIG. 1;

FIG. 3B is the reverse side of the card illustrated in FIG. 3A with the corresponding English translation of that word printed thereon;

FIG. 4 is a rolling dice having six sides with each of the six French pronouns printed on each face of the dice;

FIG. 5 is a plan view of the six sides (faces) of the rolling dice shown in FIG. 4;

FIG. 6 is a rolling dice having six sides as in FIG. 4 with the six verb tenses (present, passé, passé/compose, future, conditional, imparfait) printed on each face of the dice; and,

FIG. 7 is a plan view of the six sides (faces) of the rolling dice shown in FIG. 6.

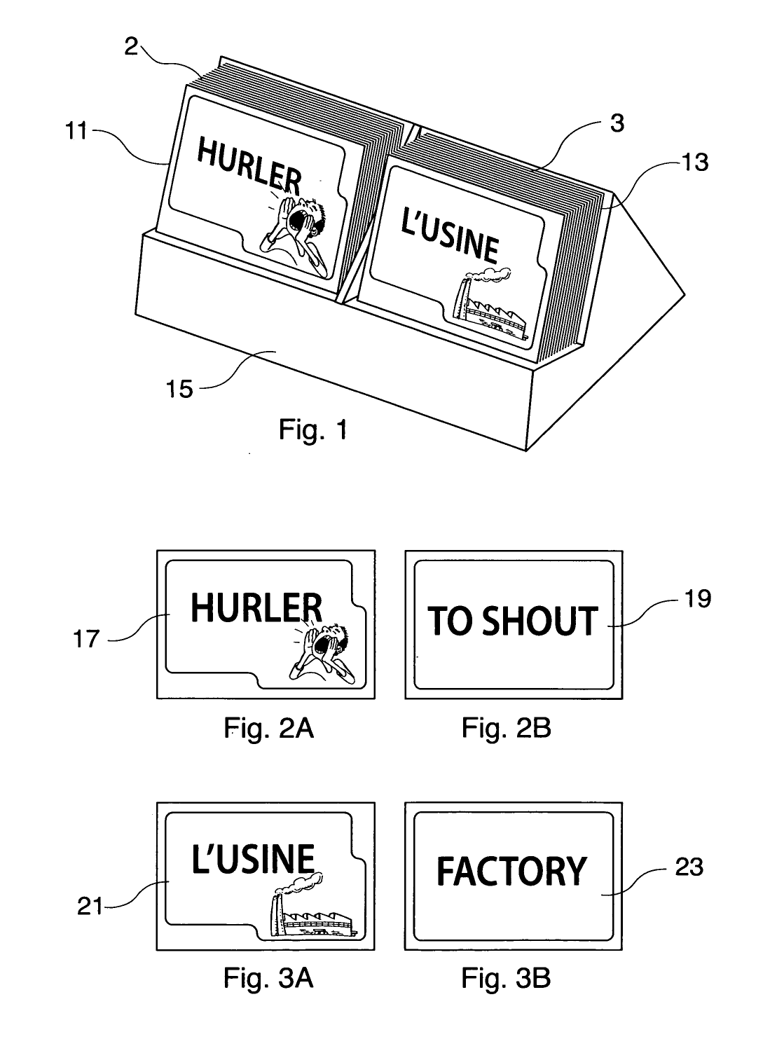

### DETAILED DESCRIPTION OF THE INVENTION

The present invention can be used as a method of improving a person's skill in foreign language such as the French language, although it can be adapted for improving a person's skill in other foreign languages as well. For the sake of simplicity of illustration, however, the present invention will be described as a method of improving a person's vocabulary in French. The invention may be used as a game by two or more players or it can even be used alone by one person, a sole learner, although it is preferably played by two or more players.

In order to play the game by two or more persons, and referring to the various figures hereinbefore described, a player removes the front card from the left side deck of cards which are displayed in the left rack 11 placed in a suitable stand 15 which may be made of plastic, metal or wood, and also has a right rack 13 placed in the stand 15 next to the deck of cards in the left rack 11. Although a stand having two adjacent racks is used for convenience of illustration, the two decks of cards may be placed side-by-side in any arrangement on a flat surface or any other stand. All cards may be flash cards and may be color coded as to parts of speech, such as, verbs, nouns, adjectives and adverbs. A front card of the left deck of cards is shown separately in FIG. 2A and is identified by reference number 17. The reverse side of the front card 17 is shown in FIG. 2B and is identified by the reference numeral 19 having the English translation of that verb printed thereon. Thus, as it can be seen, FIG. 2A features the verb and its English translation is featured in FIG. 2B. Similarly, the front card of the deck of cards on the right is shown in FIG. 2A identified by the numeral 21 and its English translation on the reverse side is featured by the numeral 23.

8

In order to play the game using the method of this invention, a player:

1. translates the verb in English using the cartoon character as a clue (see FIGS. 2A, 2B);

2. identifies the noun in English, as illustrated in FIGS. 3A, 3B;

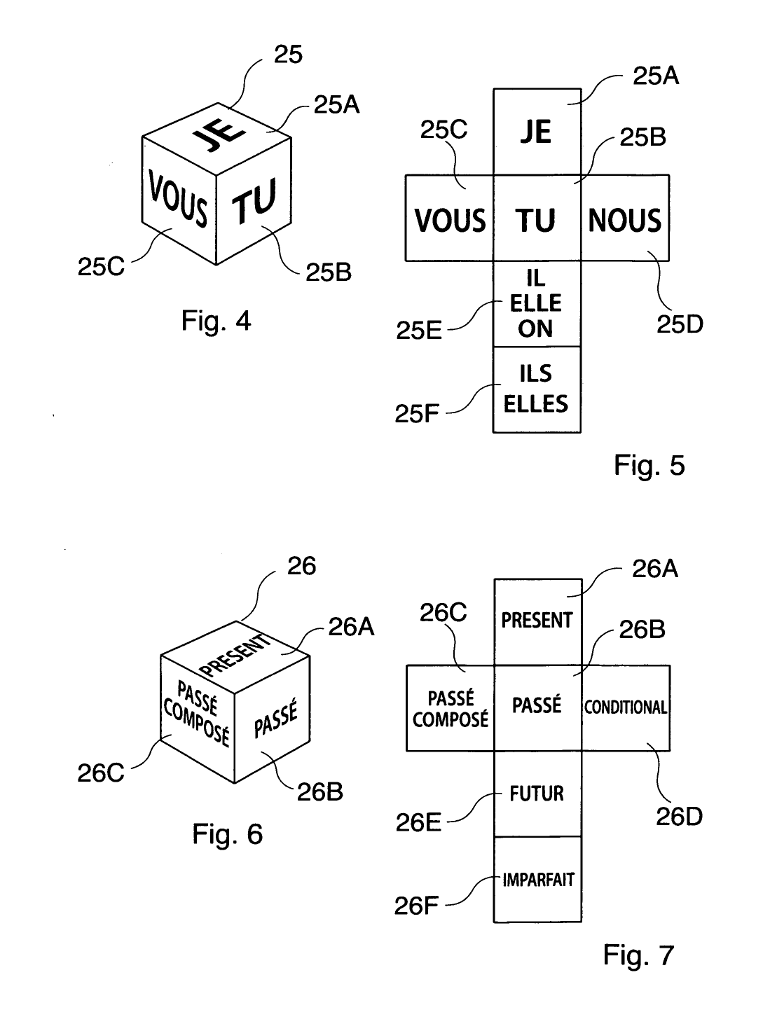

3. rolls the dice 25 which will display a pronoun on the face of the dice, having six faces printed with the French pronouns, “je”, “tu”, “il/elle/on”, “nous”, “vous” and “ils/elles”, see FIGS. 4 and 5;

4. form a sentence based on all three words (verb, noun, pronoun) with the pronoun and verb agreeing in the present tense.

Invariably, the resulting sentences formed using the above steps will be humorous and thus provoke conversation and dialogue among the players in order to form the correct sentence. There is no score kept in the game. The method described herein thus promotes the players ability to improve his or her French vocabulary and formation of correct sentences.

The method of this invention may also be used for more advanced play for those with more advanced knowledge of the language. The advanced play uses an additional rolling dice having six sides (faces) with the six advanced verb tenses thereon, i.e., present, passé, passé compose, future, conditional and imparfait. See FIGS. 6 and 7. The dice for the advanced play may be rolled alone or rolled together with the rolling dice for the regular play described in connection with the dice used in FIG. 5.

It must be mentioned that the game described using the method of this invention is not intended to be a comprehensive tutorial in the French language. It is only intended to introduce a player to new but useful words in order to promote conversation among the players. In addition, the method described herein teaches the meanings of words through translation that makes the word more memorable. Any type of cards may be used with the words printed thereon in accordance with the method described herein.

From the foregoing description, it can be appreciated that the method described for improving a person's skill in the French language can be applied to other languages as well. This simply requires the use of two different decks of cards and an appropriate dice but otherwise the game may be played by the method described herein.

1. A method of improving a person's skill in foreign language using a system of playing cards and a rolling die comprising:
(a) using two decks of flash cards, one deck consisting of individual cards each having a verb in a foreign language and an illustrative cartoon printed on one side thereof, and an English translation of said foreign language verb printed on the reverse side of each of said cards, and the other deck consisting of individual cards each having a noun in said foreign language and an illustrative cartoon printed on one side thereof, and an English translation of said foreign language noun printed on the reverse side of each said card from the other deck;
(b) drawing one card from one deck of cards and drawing another card from said other deck of cards;
(c) rolling said die having six sides, each side having a pronoun printed thereon in the same foreign language provided on each of said cards, and
(d) forming a sentence based on the three words from said first card, said second card and said rolling die.

2. A method as in claim 1 wherein the foreign language is in French and said rolling die has six faces each face having printed thereon the French pronouns “je”, “tu”, “il/elle/on”, “nous”, “vous” and “ils/elles.”

3. A method as in claim 1 using a rolling die having six sides featuring six French verb tenses with each side displaying the printed verb tense, present, passé, passé composé, future, conditional and imparfait, respectively.

4. A method as in claim 1 using two dice, a first die having six sides with each side having printed thereon one of the six French pronouns “je”, “tu”, “il/elle/on”, “nous”, “vous” and “ils/elles” and the second die having six sides with each side having printed thereon one of the six verb tenses present, passé, passé composé, future, conditional and imparfait, wherein said two dice are rolled separately or simultaneously.
